(19) United States
(12) Patent Application Publication
(10) Pub. No.: US 2004/0197616 A1
(43) Pub. Date: Oct. 7, 2004

(54) Oxidant-enriched fuel cell system

(76) Inventors: David J. Edlund, Bend, OR (US); Arne LaVen, Bend, OR (US); William A. Pledger, Bend, OR (US); Curtiss Renn, Bend, OR (US)

Correspondence Address: KOLISCH HARTWELL, P.C., 520 S.W. YAMHILL STREET, SUITE 200, PORTLAND, OR, 97204, US

(21) Appl. No.: 10/810,960

(22) Filed: Mar. 25, 2004

Related U.S. Application Data
(60) Provisional application No. 60/459,866, filed on Apr. 1, 2003.

(51) Int. Cl. H01M 8/18; H01M 8/10; H01M 2/14

(52) U.S. Cl. 429/19; 429/32; 429/38

(57) ABSTRACT

Fuel cell systems that include at least one fuel cell stack adapted to receive a fuel stream containing hydrogen gas or other proton source, and an oxidant stream containing oxygen gas. The systems include an oxidant supply system adapted to deliver an enriched, or concentrated, oxidant stream to the fuel cell stack. In some embodiments, the oxidant supply system is adapted to receive an air stream and produce an oxygen-enriched stream therefrom. In some embodiments, the fuel cell system includes a water-recovery system adapted to recover water produced in the fuel cell stack, such as may be recovered from the cathode exhaust stream from the fuel cell stack. In some embodiments, the recovered water is utilized as at least a portion of a feed stream for the fuel cell system, such as for a reformer or electrolyzer that produces hydrogen used as fuel for the fuel cell stack.

### RELATED APPLICATION

This application claims priority to U.S. Provisional Patent Application Serial No. 60/459,866, which was filed on Apr. 1, 2003 and the complete disclosure of which is hereby incorporated by reference for all purposes.

### FIELD OF THE DISCLOSURE

The present disclosure relates generally to fuel cell systems that include at least one fuel cell stack, and more particularly to a fuel cell system adapted to deliver an oxygen-enriched oxidant stream to a fuel cell stack.

### BACKGROUND OF THE DISCLOSURE

Fuel cells are electrochemical devices that produce an electric current and water through the electrochemical reaction of an oxidant and a fuel in the form of a proton source. The most common fuel is hydrogen gas, and the most common oxidant is oxygen gas, which typically is delivered in the form of air. In practice, the fuel is delivered to an anode region of the fuel cell, the oxidant is delivered to a cathode region of the fuel cell, and the anode and cathode regions are separated by an ion-permeable electrically insulating membrane that is selected for its favorable properties under the design and operating conditions of the fuel cell.

The electric current produced by a single fuel cell may be supplemented by connecting two or more fuel cells together. A plurality of connected fuel cells is commonly referred to as a fuel cell stack. The fuel cells in a fuel cell stack are typically connected in series. Fuel cell stacks may be incorporated into a fuel cell system, which generally includes a source of hydrogen gas or other fuel for the fuel cell stack, and which typically also includes Other components adapted to facilitate the conversion of fuel and oxidant into electricity.

The performance of a fuel cell is generally characterized by its gravimetric and volumetric energy density (W/kg and W/L, respectively), as well as by its polarization curve. The polarization curve relates to the voltage produced at a given current. For example, a proton-exchange membrane (PEM) fuel cell operating On substantially pure hydrogen and non-polluted air, both at a pressure in the range of approximately 1 bar absolute (bara) and 1.5 bara pressure, will produce 0.7 V/cell at a current density of in the range of approximately 0.4 A/cm² and 0.5 A/cm².

Several factors can contribute to a degradation or reduction in performance of a fuel cell. In particular, the partial pressure of oxygen at the cathode has a strong influence on the performance of a fuel cell. Increasing the partial pressure of oxygen will result in an increase in cell voltage at a given current density or, alternatively, an increase in current density at a given cell voltage. Since air (approximately 21% oxygen, 78% nitrogen, 1% argon, by volume) is the most economical oxidant for almost all common (above-water, non-space) applications, options for increasing the partial pressure of oxygen are limited. An often-practiced way of achieving an increase in oxygen partial pressure while using air as the oxidant is to pressurize the air that is supplied to the cathode. This practice has been documented for PEM fuel cells using air at pressures of 3 bara and above. The drawback to this approach is that considerable energy is required to compress the air, the compressor makes excessive noise, and the compressor requires more maintenance than is desirable.

Another method for increasing the average partial pressure of oxygen at the cathode region of a fuel cell is to supply an excess of air to the cathode so that it is impossible to consume all of the oxygen as the fuel cell is used to produce an electric current. For example, at least two- or three-times excess air may be used. By this it is meant that the amount of air that is delivered to the cathode region is at least 200% of the stoichiometrically required amount of air to react with the fuel stream delivered to the anode region of the fuel cell. However, doubling, tripling or otherwise significantly increasing the air flow to the cathode region of a fuel cell correspondingly results in large flows of air across the cathode. This may dry the fuel cell's membrane and/or otherwise impair the efficiency and/or operation of the fuel cell.

A related consideration is the amount of water produced by the fuel cell. A fuel cell that produces an electric current from hydrogen and oxygen gases is a net producer of water. This water must at least periodically be removed from the fuel cell so as not to impair the operation of the fuel cell. When a fuel cell stack forms a portion of a fuel cell system that includes a fuel processor that produces the hydrogen gas stream, the fuel processor may produce this stream from a feed stream that includes water. For example, electrolyzers produce a product hydrogen stream from water, while steam reformers and autothermal reformers produce the product hydrogen stream from a feed stream that includes water and a carbon-containing feedstock. In such an application, the water produced by the fuel cell stack may be used to form at least a portion of the feed stream for such a fuel processor. However, this water must be successfully recovered from the fuel cell stack in order to take advantage of the opportunity to use a product from the fuel cell stack as a feed for a fuel processor.

### SUMMARY OF THE DISCLOSURE

The present disclosure is directed to fuel cell systems that include at least one fuel cell stack adapted to receive a fuel stream containing hydrogen gas or another suitable proton source, and an oxidant stream containing oxygen gas. The fuel cell system further includes an oxidant supply system, which is adapted to deliver an enriched, or concentrated, oxidant stream to the fuel cell stack. In some embodiments, the oxidant supply system is adapted to receive an air stream and to produce an oxygen-enriched stream therefrom. In some embodiments, the oxidant supply system is adapted to produce the oxygen-enriched stream via a membrane separation process, while in others it is adapted to produce the stream via an adsorption process, such as a pressure swing adsorption process. In some embodiments, the fuel cell system includes a water-recovery system adapted to recover water produced in the fuel cell stack. In some embodiments, the recovered water is utilized as at least a portion of a feed stream for a fuel processor that produces a hydrogen gas or other fuel stream for the fuel cell system.

### BRIEF DESCRIPTION OF THE DRAWINGS

FIG. 1 is a schematic view of a fuel cell system that includes an oxygen-enrichment assembly according to the present disclosure.

FIG. 2 is a schematic view of a fuel cell with an oxygen-enrichment assembly.

FIG. 3 is a schematic view of an illustrative oxygen-enrichment assembly according to the present disclosure.

FIG. 4 is a schematic view of another illustrative oxygen-enrichment assembly according to the present disclosure.

FIG. 5 is a schematic view of another oxygen-enrichment assembly according to the present disclosure.

FIG. 6 is a schematic view of the fuel cell of FIG. 2 further including a water-recovery assembly.

FIG. 7 is a schematic diagram showing an illustrative example of a fuel cell system that includes a fuel processing assembly, an oxidant-enrichment assembly, and a water-recovery assembly according to the present disclosure.

FIG. 8 is a schematic view of an illustrative fuel processing assembly that may be used as a source of hydrogen gas.

FIG. 9 is a schematic view of another illustrative fuel processing assembly that may be used as a source of hydrogen gas.

FIG. 10 is a schematic view of another illustrative fuel processing assembly that may be used as a source of hydrogen gas.

FIG. 11 is a schematic view of another illustrative fuel processing assembly that may be used as a source of hydrogen gas.

### DETAILED DESCRIPTION AND BEST MODE OF THE DISCLOSURE

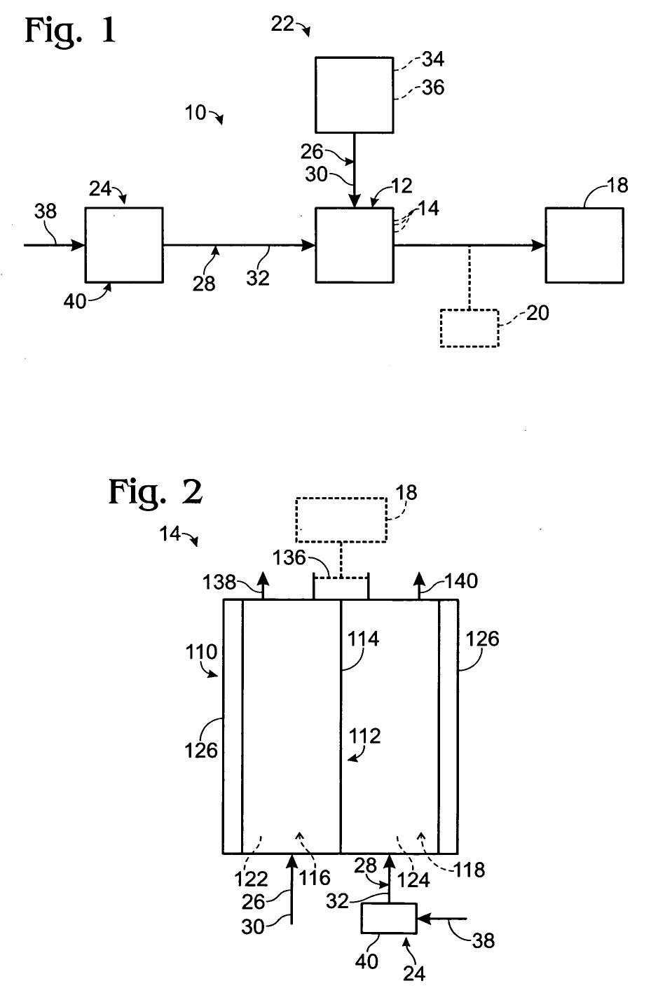

An illustrative example of a fuel cell system containing an oxygen-enrichment assembly according to the present disclosure is schematically illustrated in FIG. 1 and generally indicated at 10. System 10 includes at least one fuel cell stack 12. Fuel cell stack 12 includes at least one, and typically multiple, fuel cells 14 that are adapted to produce an electric current from fuel and oxidant streams 26 and 28 that are delivered thereto. The fuel cells are joined together, such as between common end plates, and are in fluid communication with the sources of fuel and oxidant via suitable fluid delivery conduits. Similarly, the fluids are removed from the cells (and stack) via suitable fluid removal conduits. A suitable fuel is a proton source, such as hydrogen gas 30, and a suitable oxidant is oxygen gas 32. For the purposes of simplicity, the following discussion will refer to hydrogen gas as the fuel and oxygen gas as the oxidant of the fuel cell stack. It is within the scope of the present disclosure that the fuel cell stack may be adapted to operate on other fuels and oxidants, and that the oxidant-enrichment assembly described herein accordingly may be configured to increase the concentration of such oxidants.

Fuel cell 14 may have any suitable configuration and may be configured to produce an electric current through any suitable mechanism. Illustrative examples of suitable types of fuel cells include phosphoric-acid fuel cells (PAFC), molten-carbonate fuel cells (MCFC), solid-oxide fuel cells (SOFC), alkaline fuel cells (AFC), and proton-exchange-membrane fuel cells (PEMFC, or PEM fuel cells). Occasionally PEM fuel cells are referred to as solid-polymer fuel cell (SPFC) because the membrane that separates the anode from the cathode is a polymer film that readily conducts protons, but is an electrical insulator.

For the purpose of illustration, an exemplary fuel cell in the form of a PEM fuel cell is schematically illustrated in FIG. 2 and generally indicated at 110. Proton exchange membrane fuel cells typically utilize a membrane-electrode assembly (MEA) 112 than includes an ion exchange, or electrolytic, membrane 114 located between an anode region 116 and a cathode region 118. Each region 116 and 118 includes an electrode, namely an anode 122 and a cathode 124, respectively. Each region 116 and 118 also includes a supporting plate 126, which is typically configured to act as an electrically conducting path between adjacent MEAs. Plate 126 may also physically support adjacent MEAs and/or direct the flow of fuel (hydrogen) and oxidant (oxygen) over the MEAs. In fuel cell stack 12, the supporting plates 126 of adjacent fuel cells are often united to form a bipolar plate separating the adjacent MEAs. In practice, a fuel cell stack 12 typically contains a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load.

In operation, fuel stream 26 is fed to the anode region, while oxidant stream 28 is fed to the cathode region. Hydrogen and oxygen typically combine with one another to form water via an oxidation-reduction reaction. Although membrane 114 restricts the passage of a hydrogen molecule, it will permit a hydrogen ion (proton) to pass therethrough, largely due to the ionic conductivity of the membrane. The free energy of the oxidation-reduction reaction drives the proton from the hydrogen gas through the ion exchange membrane. As membrane 114 also tends not to be electrically conductive (i.e., tends to be an electrical insulator), an external circuit 136 is the lowest energy path for the remaining electron, and is schematically illustrated in FIG. 2. In cathode region 118, electrons from the external circuit and protons from the membrane combine with oxygen to produce water and heat. Also shown in FIG. 2 are an anode purge stream 138, which may contain hydrogen gas, and a cathode exhaust stream 140, which is typically at least partially, if not substantially, depleted of oxygen gas relative to stream 28. The cathode exhaust stream also contains water that is produced in the cathode region from the hydrogen and oxygen. Fuel cell stack 12 will typically have a common hydrogen feed, air intake, and stack purge and exhaust streams, and accordingly will include suitable fluid conduits to deliver the associated streams to, and collect the streams from, the individual cells.

The electric current produced by fuel cell stack 12 may be used to satisfy the load that is applied to the stack, such as by the fuel cell system itself and/or by an energy-consuming device 18 that is configured to apply the load thereto and to draw an electric current therefrom. The energy demands of the fuel cell system may be referred to as the balance-of-plant energy requirements of the fuel cell system. At least a portion of the produced current may additionally or alternatively be stored in a battery or other suitable energy-storage device 20 for later use. This later use may include satisfying the balance-of-plant requirements of the fuel cell system and/or the applied load from device 18. Illustrative examples of devices 18 include, but should not be limited to, any combination of one or more residences, commercial offices or buildings, neighborhoods, tools, lights, computers, industrial equipment, stationary devices, signaling devices, land or sea vehicles, communication devices, etc.

As schematically illustrated in FIG. 1, fuel cell system 10 further includes sources 22 and 24 of the fuel and oxidant streams. Therefore for the purpose of discussion, the following disclosure will refer to sources 22 and 24 as respectively being sources of hydrogen gas and oxygen gas, although any other suitable fuel and oxidant for the particular fuel cell stack may be used without departing from the scope of the disclosure. For example, oxidant stream 28 may be a stream containing pure or substantially pure oxygen, air, air to which additional oxygen has been added, air that contains a reduced concentration of nitrogen or other gases, etc.

Sources 22 and 24 may include any suitable structure and may utilize any suitable mechanism for delivering the hydrogen and oxygen streams to the fuel cell stack. Illustrative, non-exclusive examples of suitable sources 22 of hydrogen gas 30 include one or more of a hydrogen storage device 34 and a fuel processor 36. A hydrogen storage device is any suitable device adapted to store and selectively deliver hydrogen gas, such as a pressurized tank or a hydride bed. A fuel processor is a device that produces, via chemical reaction of at least one feedstock, a product stream that contains hydrogen gas, with the product stream preferably being at least substantially or completely comprised of hydrogen gas. Examples of suitable fuel processors include steam reformers, autothermal reformers, electrolyzers, pyrolysis reactors, and partial oxidation reactors. The composition of the feed stream will vary depending upon the particular mechanism by which the fuel processor produces its hydrogen-containing product stream. For example, steam and autothermal reformers utilize water and at least one carbon-containing feedstock, such as at least one alcohol or hydrocarbon. For partial oxidation and pyrolysis reactors, the feedstock is at least one carbon-containing feedstock without water. For electrolyzers, the feedstock is water.

Conventional sources 24 of oxygen gas include fans and compressors that receive an air stream and deliver the air stream to the fuel cell stack, with compressors typically being configured to deliver the air stream at pressures of at least 3 bar (absolute). Similar to these conventional systems, source 24 is adapted to receive an air stream 38. However, the present disclosure is directed to fuel cell systems that are adapted to receive an oxidant stream that is enriched in oxygen (or other suitable oxidant) relative to an air (or source) stream from which the oxidant stream is at least partially (or completely) obtained. Accordingly, besides a fan, blower, positive displacement compressor or other suitable structure for receiving an air stream, source 24 further includes an oxygen-enrichment assembly 40 that is adapted to produce an oxidant stream 28 that has a greater concentration of oxygen gas than air stream 38. Therefore, while air typically comprises approximately 20-21% oxygen (by volume), oxidant stream 28 comprises a higher concentration of oxygen than the air stream from which the oxidant stream is harvested, derived or otherwise obtained. As discussed in more detail herein, the oxygen-enrichment assembly is adapted to produce an oxidant stream that contains at least 30% oxygen, and in some embodiments, at least 50% oxygen, such as 70-99% oxygen (by volume). Described in other terms, the oxygen-enrichment assembly is adapted to receive an air stream 38 and to produce an oxidant stream 28 containing an oxygen concentration that is at least 50%, and preferably at least 100%, greater than the concentration of oxygen gas present in air stream 38. Unless otherwise indicated herein, percentages will be expressed on a molar basis. Oxygen source 24 may also be referred to as an air delivery system that is adapted to deliver a stream containing oxygen gas to at least the cathode region of a fuel cell stack. As discussed, this system includes suitable structure for receiving an air stream, as well as an oxygen-enrichment assembly 40.

Oxygen-enrichment assembly 40 may be adapted to increase the relative concentration of oxygen gas 32 in oxidant stream 28 via any suitable mechanism, such as by at least one of a chemical reaction and a separation process that selectively removes at least oxygen or nitrogen from the air stream. In FIG. 3, an example of an oxygen-enrichment assembly that utilizes a pressure-driven separation process is shown. In FIG. 3, the oxygen-enrichment assembly includes at least one oxygen-selective membrane 42 through which oxygen gas may permeate or otherwise pass, but through which at least a portion (and preferably a substantial portion or all) of the other components of air stream 38 cannot pass. As somewhat schematically depicted in FIG. 3, the oxygen-enrichment assembly defines a compartment 44 in which air stream 38 (or at least a portion thereof) is exposed to the oxygen-selective membrane, with the air stream typically being introduced into the compartment at a pressure greater than atmospheric pressure, such as a pressure of at least 2 bara, such as a pressure in the range of 2-10 bara. The portion of the air stream that passes through the membrane is used to form oxidant stream 28, while the remaining portion of the air stream forms a byproduct stream 46 that has a reduced concentration of oxygen gas than was present in air stream 38. Accordingly, byproduct stream 46 may be referred to as a nitrogen-enriched stream, or a reduced-oxygen stream. Streams 28 and 46 may also be referred to as oxygen-enriched air streams and nitrogen-enriched air streams, respectively. Stream 46 may be exhausted or used for other applications. For example, stream 46 may be used to pressurize a supply of a liquid fuel, such as disclosed in U.S. patent application Ser. No. 10/379,496, which was filed on Mar. 3, 2003, is entitled “Feedstock Delivery System and Fuel Processing Systems Containing the Same,” and the complete disclosure of which is hereby incorporated by reference for all purposes.

Oxygen-selective membrane 42 may be formed from any suitable oxygen-selective composition, with polymeric membranes being commercially available for producing a stream that contains approximately 30% oxygen by volume from a conventional air stream. It is within the scope of the disclosure that more than one oxygen-selective membrane may be used, with the membranes often being supported by a suitable porous material against the pressure at which the air stream is delivered into the compartment. Examples of suitable supports include porous polymer materials, porous ceramic materials, metal screens and the like. The membranes also may have a variety of configurations, such as planar or tubular configurations.

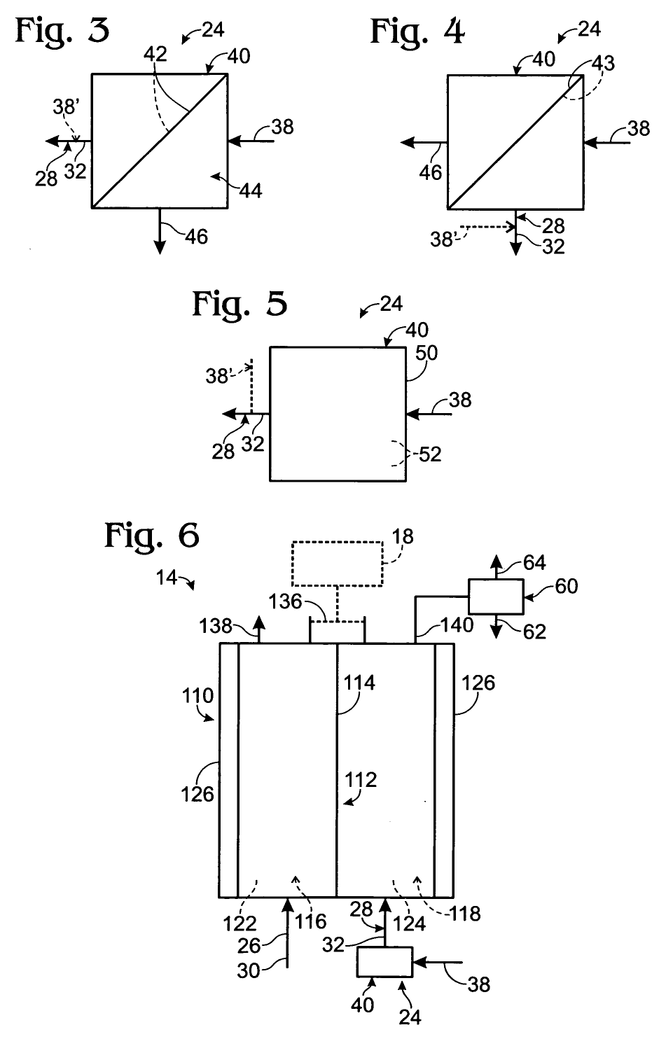

It is also within the scope of the present disclosure that the oxygen-enrichment assembly may utilize at least one nitrogen-selective membrane, such as indicated in FIG. 4 at 43. In such an embodiment, the portion of air stream 38 that passes through the membrane will form a nitrogen-enriched, or reduced oxygen, (air) stream (indicated at 46 in FIG. 4) that contains a greater concentration of nitrogen gas and a reduced concentration of oxygen gas relative to the air or other stream from which it was formed. Similarly, the portion of stream 38 that does not pass through the membrane will form oxygen-enriched (oxidant/air) stream 28.

In FIG. 5, another illustrative example of a suitable oxygen-enrichment assembly 40 is shown. As shown, the assembly includes at least one pressure swing adsorption (PSA) unit, or assembly, 50, which has been schematically illustrated in FIG. 5. PSA is a commercial process that is based on the selective adsorption of nitrogen and other constituents of air on a high-surface-area adsorbent medium. PSA is typically a multi-bed process, as schematically illustrated with dashed lines at 52 in FIG. 5. Each bed 52 contains adsorbent media, and the beds are operated in successive pressurization/depressurization cycles. During the pressurization cycle, chemical species present in air stream 38 (other than oxygen) are adsorbed, thereby allowing substantially pure oxygen gas to pass through the bed. During the depressurization cycle the previously adsorbed species are desorbed, thereby regenerating the bed. PSA is capable of producing from air stream 38 a stream of oxidant 28 that contains at least 70% (by volume) oxygen gas, and preferably at least 90% (by volume) oxygen gas. As a variant, a PSA assembly may produce the oxygen-enriched stream by selectively adsorbing oxygen from the air stream.

A benefit of supplying an oxygen-enriched oxidant stream to the cathode regions of the fuel cells is that air pollutants present in the ambient air from which air stream 38 is obtained are (at least substantially, if not completely) removed during the process of generating the oxygen-enriched oxidant stream. For example, many urban air pollutants, as well as many chemical-warfare agents and other battlefield air contaminants can have a harmful effect on the performance of a PEMFC. Another benefit is the increase in power density that is associated with operating the fuel cells at higher partial pressure of oxygen gas. Another potential benefit is that the use of an oxygen-enriched stream permits at least an equivalent amount of oxygen to be provided to the fuel cell stack but at an overall lower flow rate of fluid. As such, water present in the cathode exhaust stream may be more readily recovered than a comparable stream having a much higher nitrogen content and/or much lower partial pressure of water. These illustrative benefits are not required to be realized together or in all embodiments of the present disclosure.

The degree of increased oxygen concentration to be used with a particular fuel cell stack may vary depending upon a variety of factors, including the particular type of fuel cell stack being used, user preferences, the desired flow rate of oxidant stream 28, the available capacity of assembly 40, etc. When a flow rate of oxidant stream 28 is desired that is greater than the available capacity of assembly 40, the concentration of oxygen gas in stream 28 may be reduced to an intermediate level (less than produced by assembly 40, but greater than originally present in air stream 38) by adding a secondary air stream thereto. This is schematically illustrated in FIGS. 3-5 with a secondary air stream 38′. As an illustrative example, if an oxidant stream 28 is desired that contains at least 30% oxygen, and if assembly 40 is adapted to produce an oxidant stream containing greater than this concentration of oxygen gas (such as at least 50%, 70%, 90%, etc.), it may be desirable to implement a smaller assembly 40 than would be required to produce the total flow rate of stream 28 to be used by the fuel cell stack, with the remaining portion of the flow rate being provided by secondary air stream 38′.

Because oxidant stream 28 has a higher concentration of oxygen gas than is conventionally present in air, a lower flow rate of this stream is required to deliver an equivalent flow rate of oxygen gas. Because the oxidant stream contains a lower concentration of nitrogen gas than a conventional air stream, the cathode exhaust stream 140 will contain a higher concentration of water (and/or a higher partial pressure of water vapor) than the corresponding exhaust stream of a fuel cell in which the oxidant stream is an excess air stream. It should be recalled that water is a product from the electrochemical reaction between hydrogen and oxygen in the cathode region of a fuel cell. In the case of a PEM fuel cell, this product water is expelled from the cathode region in cathode exhaust stream 140. This product water tends to be very pure and may be used for such illustrative (non-exclusive) applications as make-up water for a PEM fuel cell, feedstock water for a fuel processor that utilizes a feed stream that includes water, a water supply for other processes, potable drinking water, etc. Accordingly, it is within the scope of the present disclosure that the product, or recovered, water stream may be delivered to the fuel processor for use as at least a portion of a feed stream, to a water source or supply for the fuel cell system, to a source or supply of potable water, to a water supply for other applications, etc.

When normal air is supplied to the cathode region in excess of two-fold to three-fold of the stoichiometrically required amount of oxygen, the water present in the cathode exhaust stream is so diluted by the remaining volume of air that only a small fraction of the water may be effectively recovered. In contrast, when oxygen-enriched oxidant stream 28 is supplied to the cathode region, then the water in the cathode exhaust stream will be less diluted and thereby easier to recover. The degree to which the water present in stream 140 is diluted will tend to decrease as the concentration of oxygen gas in stream 28 increases.

In FIG. 6, the illustrative PEM fuel cell 14 from FIG. 2 is shown with a water-recovery assembly 60 shown receiving cathode exhaust stream 140 and producing a product, or recovered, water stream 62 therefrom, with the remaining (gaseous) components of the cathode exhaust stream forming stream 64. Water-recovery assembly 60 may include any suitable structure for recovering water from stream 140, and may include various knockout assemblies, water-permeable membranes, heat exchangers to cool the cathode exhaust stream, and the like. Heat exchange may be performed with any suitable cooler fluid stream or structure.

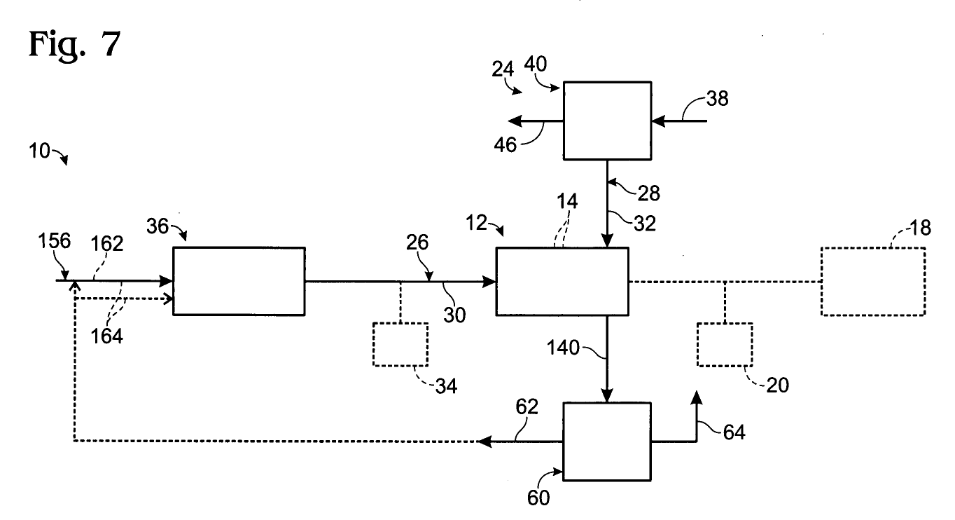

In FIG. 7 a schematic diagram is shown and demonstrates an example of a fuel cell system that includes an oxygen-enrichment assembly 40 and a water-recovery assembly 60 according to the present disclosure. Assemblies 40 and 60 schematically and respectively represent any suitable oxygen-enrichment and water-recovery assemblies, such as those disclosed, illustrated and/or incorporated herein. As shown, the fuel cell system includes a source 22 of hydrogen gas 30 in the form of a fuel processor 36 that produces a stream containing at least substantially pure hydrogen gas from at least one fuel stream. At least a portion of this stream of hydrogen gas may form fuel stream 26 for fuel cell stack 12. Similar to the above discussed oxygen-enrichment and water-recovery assemblies, source 22 and fuel processor 36 may take any suitable form, such as those described, illustrated and/or incorporated herein.

As used herein, the fuel processors 36 may be described as being, or being components of, fuel processing assemblies, with it being understood that the fuel processors have been schematically illustrated and typically (but are not required to) include such peripheral structural various sensors, fluid conduits, controllers, heating assemblies, flow regulators, housings, etc. Similarly, the fuel processors may also be described as being, or as including, at least one hydrogen-producing region, as the fuel processor does not have to be (although it may be) a stand-alone structure. For example, it is within the scope of the present disclosure that the hydrogen-producing region may be a stand-alone region, may be integrated with at least one other functional component of the fuel cell system, may be housed together with at least one other functional component of the fuel cell system, etc.

As discussed, fuel cell stacks are net producers of water, with water and an electric current being formed from the hydrogen (fuel) and oxygen (oxidant) that are respectively delivered to the anode and cathode regions of the fuel cells in the stack. However, when the oxygen gas is delivered as an air stream, the cathode exhaust stream contains a substantial amount of nitrogen gas. As the air stream is often delivered at a flow rate that is five times, if not ten times, the stoichiometrically required amount of oxygen gas, this only further increases the amount of nitrogen gas present in the cathode exhaust stream. While it may still be possible to recover some water from this stream, commercially practicable recovery of this water would be difficult. However, when oxidant stream 28 contains a greater, and especially a substantially greater, concentration of oxygen gas than is present in air, such as through the utilization of oxygen-enrichment assembly 40, the amount of nitrogen gas in the cathode exhaust stream is substantially reduced. As such, the partial pressure of water in the cathode exhaust stream is comparatively much higher, with this water being much easier to recover than water in a comparable cathode exhaust stream from a fuel cell operated to which the same amount of oxygen gas was delivered, but in the form of air.

A potential reason to recover this water, other than simply for conservation purposes, becomes more apparent when the fuel cell stack forms part of a fuel cell system that includes a fuel processor which utilizes water as a feedstock to produce hydrogen gas. For example, steam and autothermal reformers produce hydrogen gas from feed streams that include water and at least one carbon-containing feedstock, and electrolyzers produce hydrogen gas from a feed stream that consists (or consists essentially) of water. As a more detailed example, in the context of a steam reformer, at least half, and in some embodiments, at least 60% or more of the hydrogen gas produced is produced from the water present in the feed stream(s). It is within the scope of the present disclosure that at least 50%, and preferably at least 60%, at least 75%, at least 90%, or even all of the water required as a feedstock for the fuel processor may be recovered from the cathode exhaust stream of the fuel cell stack. Expressed in other terms it is within the scope of the present disclosure that the oxygen-enrichment assembly and water-recovery assembly may cooperate to produce a recovered, or product, water stream that has a flow rate that is at least 50%, at least 75%, at least 90%, equal to, or even greater than, the flow rate of water in the feed streams(s) that are utilized by the fuel processor to produce the product hydrogen stream. The utilization of recovered water stream 62 to form at least a portion of the feedstock for a fuel processor 36 is schematically illustrated in dashed lines in FIG. 7.

As an illustrative, non-exclusive example of how oxygen-enrichment and water-recovery assemblies 40 and 60 may cooperate to provide a recovered water stream that may be used as a feedstock for a fuel processor in a fuel cell system, consider a fuel cell system with a fuel cell stack that is adapted to provide 6 kW of net power output. With the fuel processor utilizing a steam reforming reaction to produce hydrogen gas from at least one feed stream containing water and carbon-containing feedstock having a 2:1 steam to carbon ratio, the fuel cell stack having an average efficiency of 50%, approximately 3 mol/minute of water to the fuel processor may produce approximately 3.1 mol/minute of hydrogen gas in the product hydrogen stream. Oxygen-enrichment assembly 40 may deliver approximately 3.6 mol/minute of oxygen-enriched air to the cathode region of the fuel cell stack, with a cathode exhaust stream being emitted that contains approximately 3.1 mol/minute water, approximately 3.1 mol/minute oxygen, and 0.3 mol/minute nitrogen. Water-recovery assembly 60 may receive this stream and recover at least 2.5 mol/minute of water therefrom. It is expected that between 2.6 and at least 2.8 mol/minute of water may be recovered from this stream. Expressed in other terms, the water-recovery assembly may recover at least 60%, and preferably at least 75%, 80%, 90% or more of the water present in the cathode exhaust stream. Additional water, such as approximately 0.2-0.9 mol/minute may be recovered from a combustion exhaust stream from a heating assembly used to heat the fuel processor. As discussed, this is but an illustrative example and is not intended to limit the scope of the present disclosure, as many other configurations of fuel cell systems, fuel processors, flow rates, operating conditions and efficiencies, feedstocks, and the like may be utilized without departing from the scope of the present disclosure.

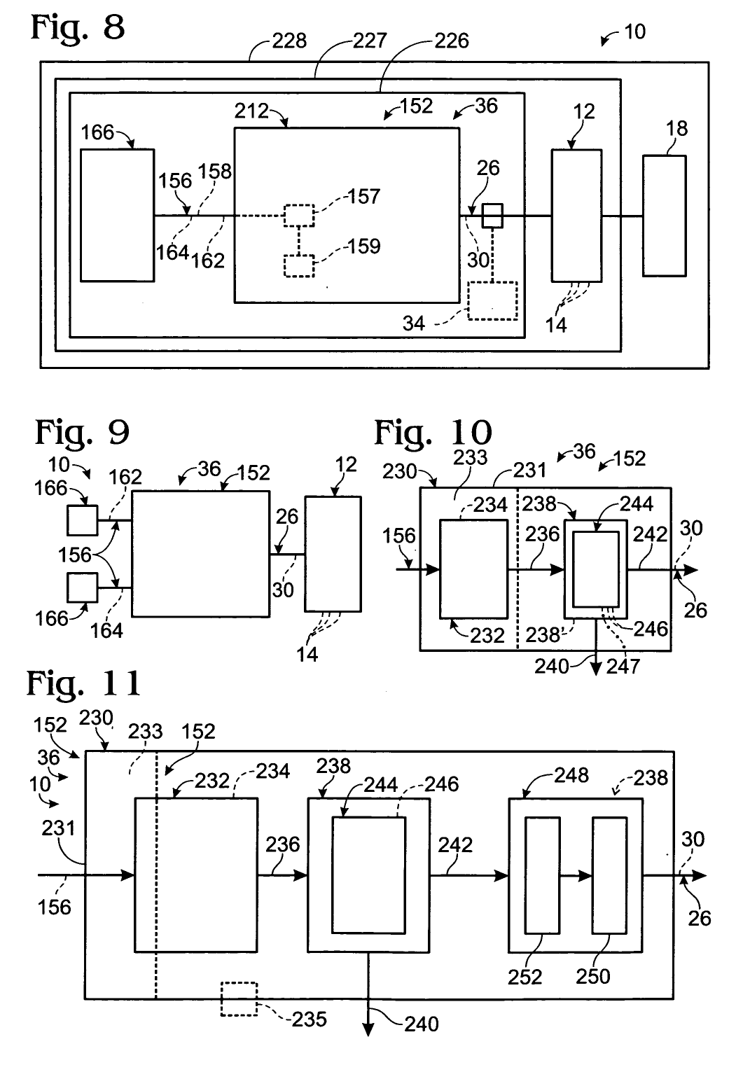

As discussed, a suitable source 22 of hydrogen gas for the fuel cell stack is a fuel processor 36 that is adapted to produce hydrogen gas by chemical reaction of at least one feedstock, such as may be delivered to the fuel processor in one or more feed streams. An illustrative example of a fuel processor 36 that is adapted to produce hydrogen gas from at least one feed stream containing at least a carbon-containing feedstock is shown in FIG. 8 and generally indicated at 152. Some fuel processors are adapted to produce a fuel stream 26 that contains at least substantially pure hydrogen gas 30, from at least one vaporized (or gaseous) feedstock, such as may be delivered in one or more streams 156. In such an embodiment, the feedstock may be delivered to the fuel processor in a vaporized (or gaseous) state, or alternatively the fuel processor may include a vaporization region 157 in which at least a portion of the feedstock is vaporized, such as by heat exchange with a higher-temperature fluid stream of structure, and/or by a suitable burner or other heating assembly 159, as indicated in dashed lines in FIG. 8.

It is within the scope of the present disclosure that assemblies 40 and 60 may be used with any of the fuel processors illustrated, described and/or incorporated with respect to FIGS. 7-11. For the purpose of simplifying these figures and permitting the figures to focus upon illustrating examples of suitable structure for the fuel processors, assemblies have not been illustrated in FIGS. 8-11. As a reminder, it is also within the scope of the present disclosure that oxygen-enrichment and/or water-recovery assemblies 40 and 60 may be used with fuel cell stacks and/or systems that either do not include a fuel processor, such as when a hydrogen-storage device or supply is used without a fuel processor, or which utilize a fuel processor that does not utilize a feed stream containing a carbon-containing feedstock.

In the illustrative embodiment shown in FIG. 8, hydrogen gas 30 may be delivered to stack 12 from one or more of fuel processor 152 and/or a hydrogen storage device 34, which as discussed may include any suitable structure for storing hydrogen gas. As also shown in the illustrative embodiment shown in FIG. 8, hydrogen gas 30 from the fuel processor may be delivered to one or more of the hydrogen storage device and stack 12. Some or all of the fuel stream may additionally, or alternatively, be delivered, via a suitable conduit, for use in another hydrogen-consuming process, burned for fuel or heat, or stored for later use.

Fuel processor 152 is any suitable device that produces from at least one feedstock a product hydrogen stream (such as fuel stream 26) that contains at least substantially pure hydrogen gas. As discussed, examples of suitable mechanisms for producing hydrogen gas include steam reforming and autothermal reforming, in which reforming catalysts are used to produce hydrogen gas from at least one feed stream containing a carbon-containing feedstock and water. Other suitable mechanisms for producing hydrogen gas from at least a carbon-containing feedstock include pyrolysis and catalytic partial oxidation of a carbon-containing feedstock, in which case the feed stream does not contain water. Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol.

Feed stream(s) 156 may be delivered to fuel processor 152 via any suitable mechanism. Although only a single feed stream 156 is shown in FIG. 8, more than one stream 156 may be used and these streams may contain the same or different feedstocks. For example, when fuel processor 152 is adapted to receive a feedstock 158 that includes a carbon-containing feedstock 162 and water 164, the carbon-containing feedstock and water may be delivered in separate feed streams or in the same feed stream. For example, when the carbon-containing feedstock is miscible with water, the feedstock is typically, but not required to be, delivered with the water component of feed stream 156, such as shown in FIG. 8. When the carbon-containing feedstock is immiscible or only slightly miscible with water, these feedstocks are typically delivered to fuel processor 152 in separate streams, such as shown in FIG. 9. In FIGS. 8 and 9, feed stream 156 is shown being delivered to fuel processor 152 by a feedstock delivery system 166, which may be any suitable pump, compressor, and/or flow-regulating device that selectively delivers the feed stream to the fuel processor.

It is desirable for the fuel processor to produce at least substantially pure hydrogen gas. Accordingly, the fuel processor may utilize a process that inherently produces sufficiently pure hydrogen gas, or the fuel processor may include suitable purification and/or separation devices that remove impurities from the hydrogen gas produced in the fuel processor. As another example, the fuel processing system or fuel cell system may include purification and/or separation devices downstream from the fuel processor. In the context of a fuel cell system, the fuel processor preferably is adapted to produce substantially pure hydrogen gas, and even more preferably, the fuel processor is adapted to produce pure hydrogen gas. For the purposes of the present disclosure, substantially pure hydrogen gas is greater than 90% pure, preferably greater than 95% pure, more preferably greater than 99% pure, and even more preferably greater than 99.5% pure. Suitable fuel processors are disclosed in U.S. Pat. Nos. 6,221,117, 5,997,594, 5,861,137, and pending U.S. patent application Ser. No. 09/802,361. The complete disclosures of the above-identified patents and patent application are hereby incorporated by reference for all purposes.

For purposes of illustration, the following discussion will describe fuel processor 152 as a steam reformer adapted to receive a feed stream 156 containing a carbon-containing feedstock 162 and water 164. However, it is within the scope of the disclosure that fuel processor 152 may take other forms, as discussed above. An example of a suitable steam reformer is shown in FIG. 10 and indicated generally at 230. Reformer 230 includes a reforming, or hydrogen-producing, region 232 that includes a steam reforming catalyst 234. Alternatively, reformer 230 may be an autothermal reformer that includes an autothermal reforming catalyst. In reforming region 232, a reformate stream 236 is produced from the water and carbon-containing feedstock in feed stream 156. The reformate stream typically contains hydrogen gas and other gases. In the context of a fuel processor generally, a mixed gas stream that contains hydrogen gas and other gases is produced from the feed stream. The mixed gas, or reformate, stream is delivered to a separation region, or purification region, 238, where the hydrogen gas is purified. In separation region 238, the hydrogen-containing stream is separated into one or more byproduct streams, which are collectively illustrated at 240 and which typically include at least a substantial portion of the other gases, and a hydrogen-rich stream 242, which contains at least substantially pure hydrogen gas. The separation region may utilize any separation process, including a pressure-driven separation process. In FIG. 10, hydrogen-rich stream 242 is shown forming fuel stream 26.

An example of a suitable structure for use in separation region 238 is a membrane module 244, which contains one or more hydrogen permeable membranes 246. Examples of suitable membrane modules formed from a plurality of hydrogen-selective metal membranes are disclosed in U.S. Pat. No. 6,319,306, the complete disclosure of which is hereby incorporated by reference for all purposes. In the '306 patent, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels. Also disclosed in the above-identified application are tubular hydrogen-selective membranes, which also may be used. Other suitable membranes and membrane modules are disclosed in the above-incorporated patents and applications, as well as in U.S. Pat. Nos. 6,537,352 and 6,562,111, the complete disclosures of which are hereby incorporated by reference in their entirety for all purposes. Membrane(s) 246 may also be integrated directly into the hydrogen-producing region or other portion of fuel processor 152. The illustrative membrane configurations and support mechanisms may also (but are not required to) be utilized within oxygen-enrichment assembly 40 to support oxygen-selective membrane(s) 42 or nitrogen-selective membranes 43.

The thin, planar, hydrogen-permeable membranes are preferably composed of palladium alloys, most especially palladium with 35 wt % to 45 wt % copper, such as approximately 40 wt % copper. These membranes, which also may be referred to as hydrogen-selective membranes, are typically formed from a thin foil that is approximately 0.001 inches thick. It is within the scope of the present disclosure, however, that the membranes may be formed from hydrogen-selective metals and metal alloys other than those discussed above, hydrogen-permeable and selective ceramics, or carbon compositions. The membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen permeable membrane or membranes may take other configurations as well, such as tubular configurations, which are disclosed in the incorporated patents.

Another example of a suitable pressure-separation process for use in separation region 238 is pressure swing adsorption (PSA). A separation region containing a pressure swing adsorption assembly is schematically illustrated at 247 in dash-dot lines in FIG. 10. In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 236.

The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities are retained on the adsorbent material. The adsorbent bed periodically needs to be regenerated to remove these adsorbed impurities. Accordingly, pressure swing adsorption assemblies typically include a plurality of adsorbent beds so that at least one bed is configured to purify the mixed gas stream even if at least another one of the beds is not so-configured, such as if the bed is being regenerated, serviced, repaired, etc.

Impurity gases such as NH₃, H₂S, and H₂O adsorb very strongly on the adsorbent material and are therefore removed from stream 236 along with other impurities. If the adsorbent material is going to be regenerated and these impurities are present in stream 236, separation region 238 preferably includes a suitable device that is adapted to remove these impurities prior to delivery of stream 236 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. However, other suitable adsorbent material compositions, forms and configurations may be used.

From the preceding discussion, it should be apparent that byproduct stream 240 generally refers to the impurities that remain after hydrogen-rich stream 242 is separated from the mixed gas stream. In some embodiments, this stream will be created as the hydrogen-rich stream is formed, such as in the context of membrane separation assemblies, while in other embodiments the stream is at least temporarily retained within the separation assembly, such as in the context of pressure swing adsorption assemblies.

As discussed, it is also within the scope of the disclosure that at least some of the purification of the hydrogen gas is performed intermediate the fuel processor and the fuel cell stack. Such a construction is schematically illustrated in dashed lines in FIG. 10, in which the separation region 238′ is depicted downstream from the shell 231 of the fuel processor.

Reformer 230 may, but does not necessarily, additionally or alternatively, include a separation region that is adapted to increase the hydrogen-purity or reduce the concentration of one or more impurities of the reformate stream (or of any other product stream from a fuel processor or other hydrogen source that is delivered thereto) by a chemical process. Illustrative, non-exclusive examples of such suitable chemical processes include methanation, partial oxidation and the water-gas shift reaction. For example, compositions that may damage fuel cell stack 12, such as carbon monoxide and carbon dioxide, may be removed from the hydrogen-rich stream. The concentration of carbon monoxide should be less than 10 ppm (parts per million). Preferably, the system limits the concentration of carbon monoxide to less than 5 ppm, and even more preferably, to less than 1 ppm. The concentration of carbon dioxide may be greater than that of carbon monoxide. For example, concentrations of less than 25% carbon dioxide may be acceptable. Preferably, the concentration is less than 10%, and even more preferably, less than 1%. Especially preferred concentrations are less than 50 ppm. The acceptable maximum concentrations presented herein are illustrative examples, and concentrations other than those presented herein may be used and are within the scope of the present disclosure. For example, particular users or manufacturers may require minimum or maximum concentration levels or ranges that are different than those identified herein. Similarly, when fuel processor 152 is used with a fuel cell stack that is more tolerant of these impurities, then the product hydrogen stream may contain larger amounts of these gases.

An example of such a chemical separation process is shown in FIG. 11 at 248. As shown, region 248 receives hydrogen-rich stream 242 from separation region 238 and further purifies the stream by reducing the concentration of, or removing, selected compositions therein. In such an embodiment, where a chemical separation region is used downstream of another separation region, such as region 238, the chemical separation region may be referred to as a polishing region. However, it is also within the scope of the present disclosure that any of the fuel processors disclosed, illustrated and/or incorporated herein may include only a chemical separation region, or even no separation region at all.

Region 248 includes any suitable structure for removing or reducing the concentration of the selected compositions in stream 242. For example, when the product stream is intended for use in a PEM fuel cell stack or other device that will be damaged if the stream contains more than determined concentrations of carbon monoxide or carbon dioxide, it may be desirable to include at least one methanation region 250 that contains a methanation catalyst. Region 250 may take the form of a methanation catalyst bed 250. Bed 250 converts carbon monoxide and carbon dioxide into methane and water, both of which will not damage a PEM fuel cell stack. Polishing region 248 may (but is not required to) also include another hydrogen-producing device 252, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

Steam reformers typically operate at temperatures in the range of 200° C. and 800° C., and at pressures in the range of 50 psi and 1000 psi, although temperatures and pressures outside of these ranges are within the scope of the disclosure, such as depending upon the particular type and configuration of fuel processor being used. Any suitable heating mechanism or device may be used to provide this heat, such as a heater, burner, combustion catalyst, or the like. The heating assembly may be external the fuel processor or may form a combustion chamber that forms part of the fuel processor. The fuel for the heating assembly may be provided by the fuel processing system, by the fuel cell system, by an external source, or any combination thereof. As illustrative examples, the reformate (mixed gas) or product hydrogen streams, anode purge stream, and/or byproduct stream from a separation process may (but are not required to) be used as fuel for a burner, combustion region, or other heating assembly. In FIG. 11, a heating assembly is schematically illustrated at 235 to graphically depict not only that the fuel processor may include a heating assembly, but also that the heating assembly may be located at any suitable location relative to the fuel processor, such as within the shell of the fuel processor, or external the shell.

In FIGS. 10 and 11, reformer 230 is shown including a shell 231 in which the above-described components are contained. Shell 231, which also may be referred to as a housing, enables the fuel processor, such as reformer 230, to be moved as a unit. It also protects the components of the fuel processor from damage by providing a protective enclosure and reduces the heating demand of the fuel processor because the components of the fuel processor may be heated as a unit. Shell 231 may, but does not necessarily, include insulating material 233, such as a solid insulating material, blanket insulating material, or an air-filled cavity. It is within the scope of the disclosure, however, that the reformer may be formed without a housing or shell. When reformer 230 includes insulating material 233, the insulating material may be internal the shell, external the shell, or both. When the insulating material is external a shell containing the above-described reforming, separation and/or polishing regions, the fuel processor may further include an outer cover or jacket external the insulation.

It is further within the scope of the disclosure that one or more of the components may either extend beyond the shell or be located external at least shell 231. For example, and as schematically illustrated in FIG. 11, polishing region 248 may be external shell 231 and/or a portion of reforming region 232 may extend beyond the shell. Other examples of fuel processors demonstrating these configurations are illustrated in the incorporated references and discussed in more detail herein.

Although fuel processor 152, feedstock delivery system 166, fuel cell stack 12 and energy-consuming device 18 may all be formed from one or more discrete components, it is also within the scope of the disclosure that two or more of these devices may be integrated, combined or otherwise assembled within an external housing or body. For example, a fuel processor and feedstock delivery system may be combined to provide a hydrogen-producing device with an on-board, or integrated, feedstock delivery system, such as schematically illustrated at 226 in FIG. 8. Similarly, a fuel cell stack may be added to provide an energy-generating device with an integrated feedstock delivery system, such as schematically illustrated at 227 in FIG. 8.

Fuel cell system 10 may additionally be combined with an energy-consuming device, such as device 18, to provide the device with an integrated, or on-board, energy source. For example, the body of such a device is schematically illustrated in FIG. 8 at 228. Examples of such devices include a motor vehicle, such as a recreational vehicle, automobile, boat or other seacraft, and the like, a dwelling, such as a house, apartment, duplex, apartment complex, office, store or the like, or self-contained equipment, such as an appliance, light, tool, microwave relay station, transmitting assembly, remote signaling or communication equipment, etc.

It is within the scope of the disclosure that the various subsystems, units, devices, etc. discussed herein may, in some embodiments, share components such as processors, busses, power supplies, communication linkages, etc. with each other. In this manner, a single component may be utilized by more than one subsystem.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A fuel cell system, comprising:
a fuel processing assembly adapted to produce a product hydrogen stream containing at least substantially pure hydrogen gas from at least one feed stream;
an air delivery system adapted to receive an air stream having a concentration of oxygen gas and to produce therefrom an oxygen-enriched stream having a greater concentration of oxygen gas than the air stream, wherein the air delivery system includes at least one oxygen-enrichment assembly adapted to produce the oxygen-enriched stream from the air stream;
a fuel cell stack adapted to receive at least a portion of the product hydrogen stream and the oxygen-enriched stream and to produce an electric current therefrom; wherein the fuel cell stack is adapted to emit a cathode exhaust stream containing water; and
a water-recovery assembly adapted to receive the cathode exhaust stream and to produce a product water stream therefrom.

2. The system of claim 1, wherein the at least one feed stream comprises water.

3. The system of claim 2, wherein the product water stream forms at least 50% of the water present in the at least one feed stream.

4. The system of claim 3, wherein the product water stream forms at least 90% of the water present in the at least one feed stream.

5. The system of claim 1, wherein the at least one feed stream comprises water and at least one carbon-containing feedstock.

6. The system of claim 5, wherein the product water stream forms at least 50% of the water present in the at least one feed stream.

7. The system of claim 5, wherein the fuel processing assembly is adapted to produce the product hydrogen stream by steam reforming of the at least one feed stream.

8. The system of claim 1, further comprising at least one separation region adapted to selectively reduce the concentration of impurities present in the product hydrogen stream.

9. The system of claim 1, wherein the oxygen-enrichment assembly is adapted to selectively remove at least nitrogen gas from the air stream.

10. The system of claim 1, wherein the oxygen-enrichment assembly is adapted to separate the air stream into the oxygen-enriched stream having a greater concentration of oxygen gas than the concentration of oxygen gas in the air stream and an oxygen-depleted stream containing a greater concentration of nitrogen gas than present in the air stream.

11. The system of claim 1, wherein the oxygen-enrichment assembly includes at least one oxygen-selective membrane, with the oxygen-enriched stream containing portions of the air stream that pass through the at least one oxygen-selective membrane.

12. The system of claim 1, wherein the oxygen-enrichment assembly includes at least one pressure swing adsorption assembly adapted to produce the oxygen-enriched stream from the air stream.

13. The system of claim 1, wherein the oxygen-enrichment assembly is adapted to produce an oxygen-enriched stream containing at least 30% oxygen.

14. The system of claim 1, wherein the oxygen-enrichment assembly is adapted to produce an oxygen-enriched stream containing at least 50% oxygen.

15. The system of claim 1, wherein the oxygen-enrichment assembly is adapted to produce an oxygen-enriched stream containing at least 75% oxygen.

16. The system of claim 1, wherein the oxygen-enrichment assembly is adapted to produce an oxygen-enriched stream having a concentration of oxygen gas that is at least 50% greater than the concentration of oxygen gas in the air stream.

17. The system of claim 1, wherein the oxygen-enrichment assembly is adapted to produce an oxygen-enriched stream having a concentration of oxygen gas that is at least 100% greater than the concentration of oxygen gas in the air stream.

18. The system of claim 1, wherein the water-recovery assembly includes at least one Water-permeable membrane, with the product water stream being formed from water that passes through the at least one water-permeable membrane.

19. The system of claim 1, wherein the water-recovery assembly is adapted to deliver the product water stream to a potable water supply.

20. The system of claim 1, wherein the fuel processing assembly is adapted to receive and utilize at least a portion of the at least one feed stream and at least a portion of the product water stream.

21. The system of claim 1, wherein the oxygen-enrichment assembly is adapted to produce an oxygen-enriched stream having an oxygen concentration that is at least 30% greater than the concentration of oxygen gas in the air stream and the water-recovery assembly is adapted to produce a product water stream having a flow rate that is at least 50% as great as the flow rate of water in the at least one feed stream for the fuel processing assembly.

22. The system of claim 1, wherein the oxygen-enrichment assembly is adapted to produce an oxygen-enriched stream having an oxygen concentration that is at least 30% greater than the concentration of oxygen gas in the air stream and the water-recovery assembly is adapted to produce a product water stream having a flow rate that is at least 75% as great as the flow rate of water in the at least one feed stream for the fuel processing assembly.

23. The system of claim 1, wherein the oxygen-enrichment assembly is adapted to produce an oxygen-enriched stream having an oxygen concentration that is at least 30% greater than the concentration of oxygen gas in the air stream and the water-recovery assembly is adapted to produce a product water stream having a flow rate that is at least 100% as great as the flow rate of Water in the at least one feed stream for the fuel processing assembly.

24. The system of claim 1, wherein the oxygen-enrichment assembly is adapted to produce an oxygen-enriched stream having an oxygen concentration that is at least 100% greater than the concentration of oxygen gas in the air stream and the water-recovery assembly is adapted to produce a product water stream having a flow rate that is at least 50% as great as the flow rate of water in the at least one feed stream for the fuel processing assembly.

25. The system of claim 1, wherein the oxygen-enrichment assembly is adapted to produce an oxygen-enriched stream having an oxygen concentration that is at least 100% greater than the concentration of oxygen gas in the air stream and the water-recovery assembly is adapted to produce a product water stream having a flow rate that is at least 75% as great as the flow rate of water in the at least one feed stream for the fuel processing assembly.

26. The system of claim 1, wherein the oxygen-enrichment assembly is adapted to produce an oxygen-enriched stream having an oxygen concentration that is at least 100% greater than the concentration of oxygen gas in the air stream and the water-recovery assembly is adapted to produce a product water stream having a flow rate that is at least 100% as great as the flow rate of water in the at least one feed stream for the fuel processing assembly.

27. A method for operating a fuel cell system, the method comprising:
receiving an air stream having a concentration of oxygen gas;
producing from the air stream an oxygen-enriched stream containing a higher concentration of oxygen gas than the concentration of oxygen gas in the air stream;
delivering the oxygen-enriched stream to a cathode region of a fuel cell stack adapted to produce an electric current and water from the oxygen-enriched stream and a fuel stream, wherein the fuel cell stack is adapted to exhaust at least a cathode exhaust stream containing water;
recovering water from the cathode exhaust stream; and
utilizing at least a portion of the recovered water to produce additional fuel for the fuel stream.

28. The method of claim 27, wherein the fuel is hydrogen gas and the fuel stream contains at least substantially pure hydrogen gas.

29. The method of claim 27, wherein the producing step includes producing an oxygen-enriched stream containing at least 30% oxygen.

30. The method of claim 27, wherein the producing step includes producing an oxygen-enriched stream containing at least 50% oxygen.

31. The method of claim 27, wherein the producing step includes producing an oxygen-enriched stream having a concentration of oxygen gas that is at least 50% as great as the concentration of oxygen gas in the air stream.

32. The method of claim 27, wherein the producing step includes producing an oxygen-enriched stream having a concentration of oxygen gas that is at least 100% as great as the concentration of oxygen gas in the air stream.

33. The method of claim 27, wherein the fuel is hydrogen gas, the fuel stream includes at least water, and the utilizing step includes producing hydrogen gas from at least one feed stream, with the at least one feed stream including water recovered from the cathode exhaust stream.

34. The method of claim 33, wherein the at least one feed stream further comprises at least one carbon-containing feedstock.

35. The method of claim 34, wherein the utilizing step includes producing hydrogen gas by steam reforming water and the at least one carbon-containing feedstock.

36. A method for operating a fuel cell system, the method comprising:
producing from at least one feed stream comprising water and at least one carbon-containing feedstock a product hydrogen stream in a hydrogen-producing region of a fuel processing assembly;
receiving an air stream having a concentration of oxygen gas;
producing from the air stream an oxygen-enriched stream containing at least 50% greater concentration of oxygen gas than the concentration of oxygen gas in the air stream;
delivering at least a portion of the product hydrogen stream to an anode region of a fuel cell stack and at least a portion of the oxygen-enriched stream to a cathode region of a fuel cell stack;
producing water and an electric current from the portions of the product hydrogen stream and the oxygen-enriched stream in the fuel cell stack;
exhausting from the cathode region a cathode exhaust stream containing water;
recovering water from the cathode exhaust stream; and
delivering water recovered from the cathode exhaust stream to the hydrogen-producing region as at least a portion of the at least one feed stream for the production of additional amounts of the product hydrogen stream.

37. In a fuel cell system having a fuel processing assembly adapted to produce a product hydrogen stream from at least one feed stream, a fuel cell stack adapted to produce water and an electric current from at least a portion of the product hydrogen stream and an oxidant stream containing oxygen gas, the improvement comprising:
an air delivery system including at least one oxygen-enrichment assembly adapted to receive an air stream having a concentration of oxygen gas and to produce therefrom the oxidant stream having a greater concentration of oxygen gas than the air stream; and
a water-recovery assembly adapted to receive a cathode exhaust stream from the fuel cell stack and to produce a recovered water stream containing water recovered from the cathode exhaust stream; wherein the fuel processing assembly is adapted to receive at least a portion of the recovered water and to utilize the recovered water as a feedstock for producing the product hydrogen stream.

38. The system of claim 37, wherein the oxygen-enrichment assembly is adapted to produce an oxygen-enriched stream having an oxygen concentration that is at least 30% greater than the concentration of oxygen gas in the air stream and the water-recovery assembly is adapted to produce a recovered water stream having a flow rate that is at least 50% as great as the flow rate of water in the at least one feed stream for the fuel processing assembly.

39. The system of claim 37, wherein the oxygen-enrichment assembly is adapted to produce an oxygen-enriched stream having an oxygen concentration that is at least 30% greater than the concentration of oxygen gas in the air stream and the water-recovery assembly is adapted to produce a recovered water stream having a flow rate that is at least 75% as great as the flow rate of water in the at least one feed stream for the fuel processing assembly.

40. The system of claim 37, wherein the oxygen-enrichment assembly is adapted to produce an oxygen-enriched stream having an oxygen concentration that is at least 30% greater than the concentration of oxygen gas in the air stream and the water-recovery assembly is adapted to produce a recovered water stream having a flow rate that is at least 100% as great as the flow rate of water in the at least one feed stream for the fuel processing assembly.

41. The system of claim 37, wherein the oxygen-enrichment assembly is adapted to produce an oxygen-enriched stream having an oxygen concentration that is at least 100% greater than the concentration of oxygen gas in the air stream and the water-recovery assembly is adapted to produce a recovered water stream having a flow rate that is at least 50% as great as the flow rate of water in the at least one feed stream for the fuel processing assembly.

42. The system of claim 37, wherein the oxygen-enrichment assembly is adapted to produce an oxygen-enriched stream having an oxygen concentration that is at least 100% greater than the concentration of oxygen gas in the air stream and the water-recovery assembly is adapted to produce a recovered water stream having a flow rate that is at least 75% as great as the flow rate of water in the at least one feed stream for the fuel processing assembly.

43. The system of claim 37, wherein the oxygen-enrichment assembly is adapted to produce an oxygen-enriched stream having an oxygen concentration that is at least 100% greater than the concentration of oxygen gas in the air stream and the water-recovery assembly is adapted to produce a recovered water stream having a flow rate that is at least 100% as great as the flow rate of water in the at least one feed stream for the fuel processing assembly.
